(19) United States
(12) Patent Application Publication
(10) Pub. No.: US 2023/0131318 A1
(43) Pub. Date: Apr. 27, 2023

(54) Adaptive Romantic Reminder Notifications

(71) Applicant: Cora Nordby, Chelan, WA (US)

(72) Inventor: Cora Nordby, Chelan, WA (US)

(21) Appl. No.: 17/973,407

(22) Filed: Oct. 25, 2022

Related U.S. Application Data
(60) Provisional application No. 63/271,642, filed on Oct. 25, 2021.

(51) Int. Cl. B42F 17/34; B42F 17/16

(52) U.S. Cl. CPC B42F 17/346; B42F 17/16

(57) ABSTRACT

The main purpose of the Romantic Reminder App is to provide users with daily examples of romantic phrases and how-toes via an app, teach users how to be more romantic, and help users build stronger relationships. The Romantic Reminder App benefits both couples and singles, and can be used to strengthen existing relationships, or to aid users in creating new connections. The Romantic Reminder App will be compatible for all Android and iPhone users, and can be easily downloaded. The app provides examples of compliments and little favors to teach them ways that they can demonstrate their appreciation for their loved ones to make them feel cherished and valued.

### CROSS REFERENCE

The present Non-Provisional patent application claims priority to the Provisional Patent Application 63/271,642 filed 25 Oct. 2021 for Cora Nordby titled Romantic Reminder App and is therefore included by cross reference in its entirety.

### BACKGROUND

Daily notifications are a popular way of reminding people of important thoughts and things and enable self improvement. Some examples are themed cards printed with wise and well known sayings and poems for daily use and for daily improvement.

### SUMMARY OF THE INVENTION

The main purpose of the Romantic Reminder App is to provide users with daily examples of romantic phrases and how-toes via an app, teach users how to be more romantic, and help users build stronger relationships. Being romantic can be a struggle for many individuals, but is considered especially difficult for those who lack certain communication skills. Effective communication is an imperative element of maintaining and developing successful relationships, but can be hard to achieve or practice for many.

The Romantic Reminder App benefits both couples and singles, and can be used to strengthen existing relationships, or to aid users in creating new connections. The Romantic Reminder App will be compatible for all Android and iPhone users, and can be easily downloaded. Once the application is installed, the user can engage with questions, create a profile, then receive daily notifications and tips on how they can increase their romance levels by providing simple, yet sincere, examples on what they can say and/or do for their significant partners.

This innovative and incredibly simple-to-use relationship tool can enhance intimacy between partners, promote the growth of new relations, and can benefit all individuals who seek to be more in tune with their romantic side overall; thus, the Romantic Reminder App may also be a great benefit in the technology industry.

The disclosure not only guides individuals on how to become more proficient communicators, but also teaches them ways that they can demonstrate their appreciation for their loved ones to make them feel cherished and valued.

### BRIEF DESCRIPTION OF THE DRAWINGS

FIG. 1 displays a flow chart of the disclosure in accordance with an embodiment of the present disclosure.

FIG. 2 is a depiction of a rotating spindle with dual cams to which removable cards are attached and printed on both sides in accordance with an embodiment of the present disclosure.

FIG. 3 depicts block diagram components of the disclosed system for an index of cards in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

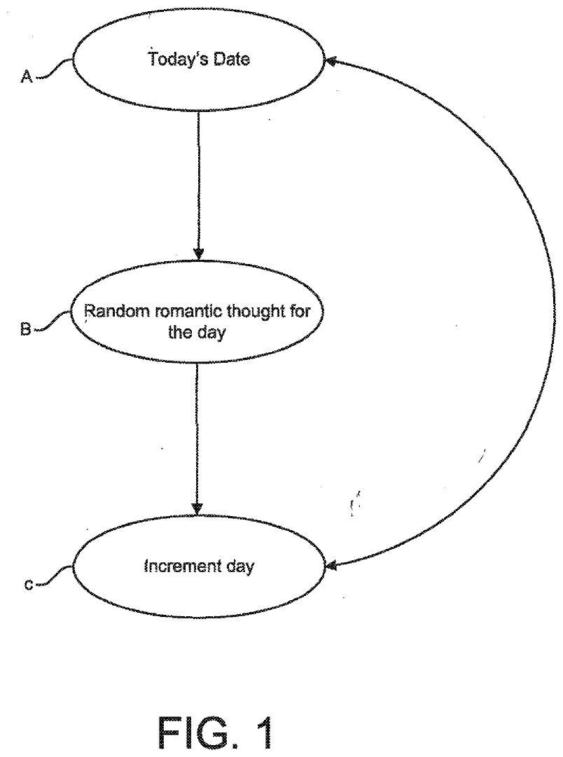

FIG. 1 is a flow chart of the disclosure in accordance with an embodiment of the present invention. Step A is “today's date,” step B random romantic thought for the day,” and step C to increment day or date. The random romantic thought comes from an AI or from a depository of predetermined romantic thoughts. Step C loops around back to step A automatically according to a decrementer or according to a calendar.

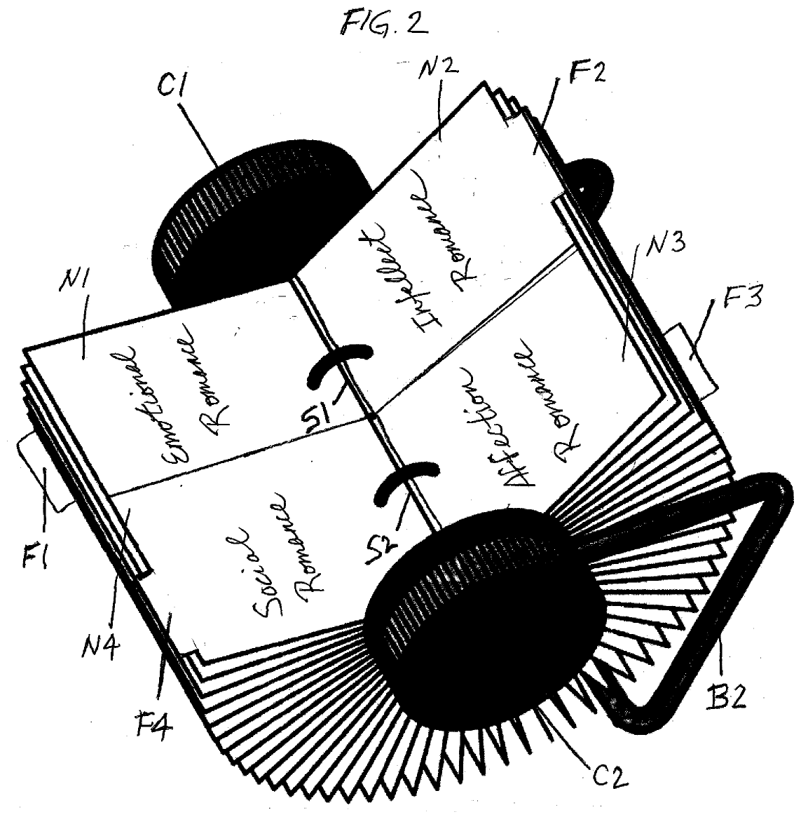

FIG. 2 is a depiction of a rotating spindle with dual cams to which removable cards are attached and printed on both sides in accordance with an embodiment of the present disclosure. The depiction includes a first note N1, a second note N2, a third note N3 and a fourth note N4. At least four flags F1, F2, F3 and F4 mark prior shared thoughts and/or instructions to come back to based on an adaptive need and selection of the user. That is an adaptive need and selection of the user includes a user choosing a sequence of a type of romantic thought and/or instruction over another type based on their needs and experiences. The depiction also includes the first rotating spindle S1, the second rotating spindle S2, the first cam C1, and the second cam C2. The stand or the bracket B2 supports the index and allows spinning and turning clockwise and counterclockwise in relation to a viewing angle of the user.

Further steps may require entering a verification code for access to the app and a short quiz on the background of a user to help determine romantic thoughts to use. For instance, how long someone has been in a relationship current and past, whether they are married current or past and personality traits. Also, what their definition of ‘romance’ might be. Also, frequency of thoughts to share on a daily basis or weekly, semi weekly etc. Accountability and how thoughtful and caring they consider themselves to be.

Significantly, the app also has the ability to allow a user to share romantic tips with friends, relations and the user community for insightful and meaningful expressions.

In one embodiment, the disclosure provides the user with randomly generated romantic ideas/tips (ideas of how to show love, caring and kindness) from a database. The user specifies preferred frequency of delivery. It is a tool to teach the user.

More advanced features allow the user to track success and record outcomes. The app can adapt based on the user's feedback of their partner's reactions to their implementation/use of the tips. The future tips are then adapted based on the learning. The adaptive feature can identify the future preferred category of the tip to be delivered, as well as adjust frequency of delivery.

For example: Social romance thoughts for the day might including “Introduce your partner to your best friend(s) today” if the user's collected feedback for this tip is positive the app would provide a similar tip in the future such as, “Introduce your partner to your coworkers today” etc. Advanced Categories of tips include social, emotional, physical, spiritual, intellectual. The app's purpose is to help the couple grow closer by supporting the user and helping the user identify what's working/not working in the relationship.”

The disclosure include your romantic thought for each day but with an adaptive feature that suggests romantic thoughts for the day depending on the users need and receiver's response/experience including:

Social romance notes N4 include thoughts for the day such as “Introduce your crush to your best friend(s) today” followed by another thought like, “Introduce your crush to your coworkers today” etc. Flag F4 marks a prior shared thought to come back to based on an adaptive need and selection of the user.

Emotional romance notes N1 include thoughts for the day such as. “Tell your crush how cute you think they are today,” followed by another thought like “Tell your crush you have their back today,” etc. Flag F1 marks a prior shared thought to come back to based on an adaptive need and selection of the user.

Affectionate romance notes N3 include thoughts for the day such as “Brush your hand across your crush's back when you walk past them today,” followed by another thought, “Greet your crush with a wet juicy kiss today,” etc. Flag F3 marks a prior shared thought to come back to based on an adaptive need and selection of the user.

Spiritual romance thoughts for the day including “Take your crush on a hike today to get closer to Nature and the Universe,” followed by another thought “Tell your crush how insightful they are about spiritual things.” etc

Financial romance thoughts for the day including “Tell your crush how you admire their earning power,” followed by another thought “Tell your crush ‘I like the way you prioritize your money needs,” etc.

Intellectual romance notes N2 include thoughts for the day such as, “Tell your crush ‘I like the way you think about things logically,” followed by another thought “I love your curiosity about nature, the way things work,” etc. Flag F2 marks a prior shard thought to return to based on an adaptive need and selection of the user.

The adaptive part comes into play by deciding if an emotional romantic thought for the day is followed by another emotional romantic thought for the next day or by an affectionate thought for the next day and so on.

The adaptive part can be triggered explicitly (on purpose) by the user or by a time expiration (how eager the user is to get another emotional thought or another affectionate thought for the next day for instance or from information received from the receiving/partner's end on the effectiveness of the thought/romantic tip provided by the app and it's positive/negative impact . . . for example the user can provides input as to how well it went/how it was received. In summary the extension is the apps on each end help the couple communicate what's working/not working in the relationship.

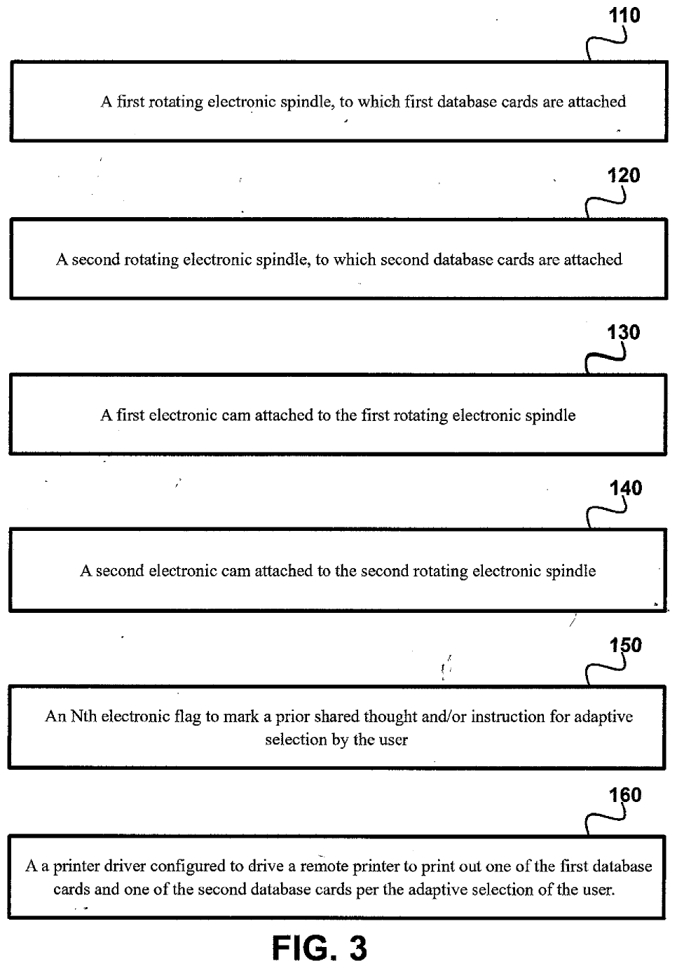

FIG. 3 depicts block diagram components of the disclosed system for an index of cards in accordance with an embodiment of the present disclosure. The disclosure is also implemented in an electronic memory which is read as instructions and data as an application.

The disclosure includes a first rotating electronic spindle 110 to which first database cards are attached and printed on both sides thereof and a second rotating electronic spindle 120 to which second database cards are attached and printed on both sides thereof. The disclosure also includes a first electronic cam 130 configured to rotate the first rotating electronic spindle 110 and display a sequence of the first database cards comprising a first sequence of shared instructions and messages on a forward side and a second sequence of shared instructions and messages on a reverse side of the cards. A second electronic cam 140 is configured to rotate the second rotating electronic spindle 120 and display another sequence of the second database cards comprising a third sequence of shared instructions and messages on a forward side and a fourth sequence of shared instructions and messages on a reverse side of the cards. An Nth electronic flag 150 is configured to mark a shared thought to come back to in the Nth sequence based on an adaptive selection of the user where N is one of the first sequence, the second sequence, the third sequence and the fourth sequence. A printer driver 150 configured to drive a remote printer to print out one of the first database cards and one of the second database cards per the adaptive selection of the user.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An index of cards for a user, the index of cards comprising:
a first rotating spindle to which first cards are attached and printed on both sides thereof;
a second rotating spindle to which second cards are attached and printed on both sides thereof
a first cam configured to rotate the first rotating spindle and display a sequence of the first cards comprising a first sequence of shared instructions and messages on a forward side and a second sequence of shared instructions and messages on a reverse side of the cards;
a second cam configured to rotate the second rotating spindle and display another sequence of the second cards comprising a third sequence of shared instructions and messages on a forward side and a fourth sequence of shared instructions and messages on a reverse side of the cards; and
an Nth flag configured to mark a shared thought to come back to in the Nth sequence based on an adaptive selection of the user where N is one of the first sequence, the second sequence, the third sequence and the fourth sequence.

2. The index of cards of claim 1, wherein the first rotating spindle turns independent of the second rotating spindle.

3. The index of cards of claim 1, wherein a clockwise action of the first cam turns the first rotating spindle in a clockwise direction and a forward side of the first cards.

4. The index of cards of claim 1, wherein a counter clockwise action of the first cam turns the rotating spindle in a counter clock wise direction and a reverse side of the first cards.

5. The index of cards of claim 1, wherein a clockwise action of the second cam turns the first rotating spindle in a clockwise direction and a forward side of the second cards.

6. The index of cards of claim 1, wherein a counter clock wise action of the second cam turns the second rotating spindle in a counter clock wise direction and a forward side of the second cards.

7. The index of cards of claim 1, wherein the Nth flags are detachable sticky tabs placed by the user based on their adaptive selection of a card from the first cards and the second cards.

8. The index of cards of claim 1, further comprising a stand attached to the first rotating spindle and to the second rotating spindle to allow independent action there between.

9. The index of cards of claim 1, wherein the first sequence of shared messages and instructions include emotionally romantic messages and instructions.

10. The index of cards of claim 1, wherein the second sequence of shared messages and instructions include intellectually romantic messages and instructions.

11. The index of cards of claim 1, wherein the third sequence of shared messages and instructions include affectionately romantic messages and instructions.

12. The index of cards of claim 1, wherein the fourth sequence of shared messages and instructions include socially romantic messages and instructions.

13. The index of cards of claim 1, further comprising a fifth sequence of shared messages and instructions including spiritually romantic messages and instructions.

14. The index of cards of claim 1, further comprising a sixth sequence of shared messages and instructions including financially romantic messages and instructions.

15. A system of cards for a user, the index of cards comprising:
a first rotating electronic spindle to which first database cards are attached and printed on both sides thereof;
a second rotating electronic spindle to which second database cards are attached and printed on both sides thereof
a first electronic cam configured to rotate the first rotating electronic spindle and display a sequence of the first database cards comprising a first sequence of shared instructions and messages on a forward side and a second sequence of shared instructions and messages on a reverse side of the cards;
a second electronic cam configured to rotate the second rotating electronic spindle and display another sequence of the second database cards comprising a third sequence of shared instructions and messages on a forward side and a fourth sequence of shared instructions and messages on a reverse side of the cards; and
an Nth electronic flag configured to mark a shared thought to come back to in the Nth sequence based on an adaptive selection of the user where N is one of the first sequence, the second sequence, the third sequence and the fourth sequence.

16. The system of cards for a user of claim 15, further comprising electronic state machine circuits configured to generate the first rotating electronic spindle and the second rotating electronic spindle.

17. The system of cards for a user of claim 15, further comprising electronic state machine circuits configured to generate the first electronic cam and the second electronic cam.

18. The system of cards for a user of claim 15, further comprising electronic state machine circuits configured to generate the Nth electronic flags.

19. The system of cards for a user of claim 15, wherein the system is stored in an electronic memory configured to be read as an application to implement the system electronically.

20. The system of cards for a user of claim 15, further comprising a printer daemon configured to drive a remote printer to print out one of the first database cards and one of the second database cards per the adaptive selection of the user.
